(19) United States
(12) Patent Application Publication
(10) Pub. No.: US 2017/0223940 A1
(43) Pub. Date: Aug. 10, 2017

(54) HYBRID CHUMMER AND CHUNKER APPARATUS

(71) Applicant: Captain Slaughter Tackle Company, Inc., Brooklyn, NY (US)

(72) Inventors: Joseph Bailey, Brooklyn, NY (US); Ruldoph Maisto, Staten Island, NY (US)

(73) Assignee: Captain Slaughter Tackle Company, Inc., Brooklyn, NY (US)

(21) Appl. No.: 15/015,617

(22) Filed: Feb. 4, 2016

(51) Int. Cl. A01K 97/02

(52) U.S. Cl. CPC A01K 97/02

(57) ABSTRACT

In one embodiment of the present invention there is provided a hybrid chummer and chunker apparatus that has a cage, a removably top section that can be secured to the cage and a bottom end cap that is configured to move away from the bottom end of the cage when submerged in water and when the top of the apparatus is pulled or yanked through the water. The apparatus further includes a tension spring secured between the top section and the bottom end cap, the tension spring configured to permit the bottom end cap to move away from the bottom end of the cage when submerged in water and when the apparatus is pulled through the water with a force that exceeds a force exerted by the tension spring.

### FIELD OF THE INVENTION

The present invention relates to a hybrid chum delivery container, for delivering chum or bait in a controlled delivery below the surface of the water to attract fish.

### BACKGROUND ART

Chum delivery containers are well known in the art of sport and recreational fishing. Such containers typically are designed to dispense particles of chum or bait either as the container moves in the water or by the natural water currents near the bottom or when impacted by a fish. While the prior art is well defined in this field, the present invention provides for a novel and unique controlled delivery system that is able to dispense much larger portion of the chum or bait rather than mostly liquid and small particles that a standard chummer or chumpot dispenses.

### SUMMARY OF THE INVENTION

In accordance with one embodiment of the present invention, there is provided a hybrid chummer and chunker apparatus that has a cage with a plurality of openings around the circumference of the cage that are designed to allow water in and out of the cage and allow chum, bait, and/or chunks of the same contained within the cage to exit the cage when submerged in water. The apparatus further includes a top section secured about a top end of the cage. The top section is removably secured about the top section. In addition, a bottom end cap is positioned about a bottom end of the cage. The bottom end cap is further configured to move away from the bottom end of the cage. The apparatus further includes a tension spring secured between the top section and the bottom end cap, the tension spring configured to permit the bottom end cap to move away from the bottom end of the cage when submerged in water and when the apparatus is pulled through the water with a force that exceeds a force exerted by the tension spring.

In other aspects of the apparatus, the bottom end of the cage may include a tab with an aperture. The tab is configured to extend through a slot defined on the bottom end cap. The apparatus further includes a locking device configured to fit through the aperture of the tab when the tab extends through the slot such that the bottom end cap of the cage is locked against the bottom end of the cage preventing movement of the bottom end cap when submerged in water.

In another aspect of an embodiment of the invention, the cage may include a plurality of openings surrounding the cage, a plurality of indented portions about the bottom end of the cage, and at least one vertical slot positioned about the cage.

The apparatus may also provide for the top section to be removably secured to the top end of the cage. This may be accomplished by having the top section with an upper structural ring secured within the top end of the cage. The upper structural ring would have an annual ring with a centered flange expanding the diameter of the annual ring. The centered flange includes a keyhole opening about a middle area of the centered flange, and the annual ring further includes a pair of opposed notches positioned adjacent to the centered flange and that face the interior of the annual ring. A top spring mount would further be provided with a vertical post and a horizontal post that extends outwardly from either side of the vertical post and for a distance that allows the vertical post to extend above and below the horizontal post. The vertical post may have a top portion above the horizontal post that is configured to extend through the keyhole opening. The vertical post may further have a bottom portion below the horizontal post positioned below the upper structural ring, and the bottom portion further includes an opening to receive an upper portion of the tension spring. A lid is also provided with a handle extending therefrom. The handle includes a pair of outwardly extending clips positioned below the lid and which fit through the opposed notches defined on the upper structural ring such that the clips are configured to position below the upper structural ring. As such when the lid is rotated away from the opposed notches such that the clips engage the upper structural ring, the lid is securely fashioned thereto and when the lid is rotated such that the clips align with the opposed notches, the lid is removable from the cage.

In other aspects, the bottom end cap may include a lower annual ring attached to the bottom end of the cage. The annual ring includes a plurality of bracket ends projected outwardly from the lower annual ring, and each bracket end has an opening there through and is configured at a position exterior to the cage. The bottom end cap further includes a tension base movable in relation to the lower structural ring.

The tension base may include a bottom plate having a plurality of slots about a peripheral edge defined along the bottom plate and where the plurality of slots correspond to the openings in the bracket ends. The bottom plate also includes a bottom key hole opening about a center area of the bottom plate. A plurality of braces are then positioned below and against the bottom plate, with one of the braces including an portion extending through the cross key hole opening. The portion extending through the cross key hole opening includes an aperture for receiving a lower end of the tension spring. A plurality of vertical arms are provided with each vertical arm being separately positioned to extend through one of the slots in the bottom plate and the corresponding opening in the bracket end on the lower annual ring. Each vertical arm has a lower portion with a width that is larger than an upper portion such that when the vertical arm is inserted through the slot movement stops at the lower portion. Each vertical arm also includes an upper cap that is secured to a top portion of the vertical arms. The upper cap has a flared end resting inside the cage along the slot defined on the cage, such that the vertical arms can slide along the slots on the cage. As assembled the tension base is configured to move away from the bottom end of the cage when a force is exerted against the tension base that is greater than the tension spring and the tension base has a tendency to return to rest against the bottom end of the cage when forces exerted by the tension spring exceeds any forces against the tension base.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1A is a perspective view of an apparatus in accordance with one embodiment of the present invention, illustrating the apparatus in a resting position;

FIG. 1B is a perspective view of an apparatus in accordance with one embodiment of the present invention, illustrating the apparatus in an open position;

FIG. 1C is a perspective view of an apparatus in accordance with one embodiment of the present invention, illustrating the apparatus from a bottom end position;

FIG. 1D is a perspective view of various components of an apparatus in accordance with one embodiment of the present invention, illustrating the top and bottom components connected by a tension spring;

FIG. 1E is an exploded perspective view of an apparatus in accordance with one embodiment of the present invention;

FIG. 2A is a perspective view of a cage used in an apparatus in accordance with one embodiment of the present invention;

FIG. 2B is another perspective view of the cage from FIG. 2A;

FIG. 3A is a perspective view of a cage and top end cap used in an apparatus in accordance with one embodiment of the present invention;

FIG. 3B is an exploded perspective view of the top end cap used in an apparatus in accordance with one embodiment of the present invention;

FIG. 4A is a perspective view of a bottom end cap used in an apparatus in accordance with one embodiment of the present invention;

FIG. 4B is another perspective view of the bottom end cap of FIG. 4A;

FIG. 4C is a perspective view of a vertical arm used in an apparatus in accordance with one embodiment of the present invention; and

FIG. 4D is an exploded perspective view of various components used in a bottom end cap for an apparatus in accordance with one embodiment of the present invention.

### DETAILED DESCRIPTION OF THE INVENTION

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or the embodiments illustrated.

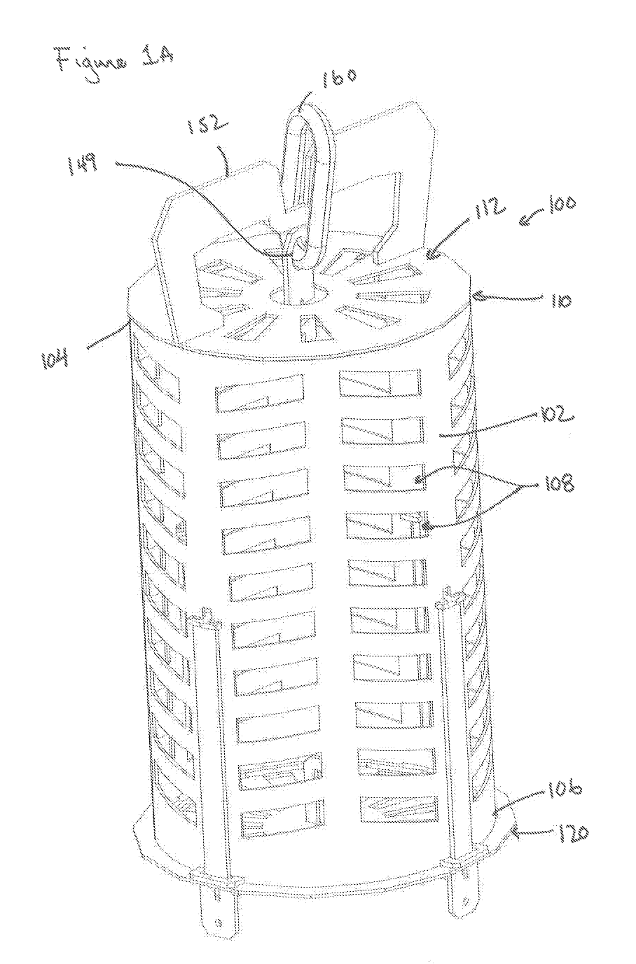

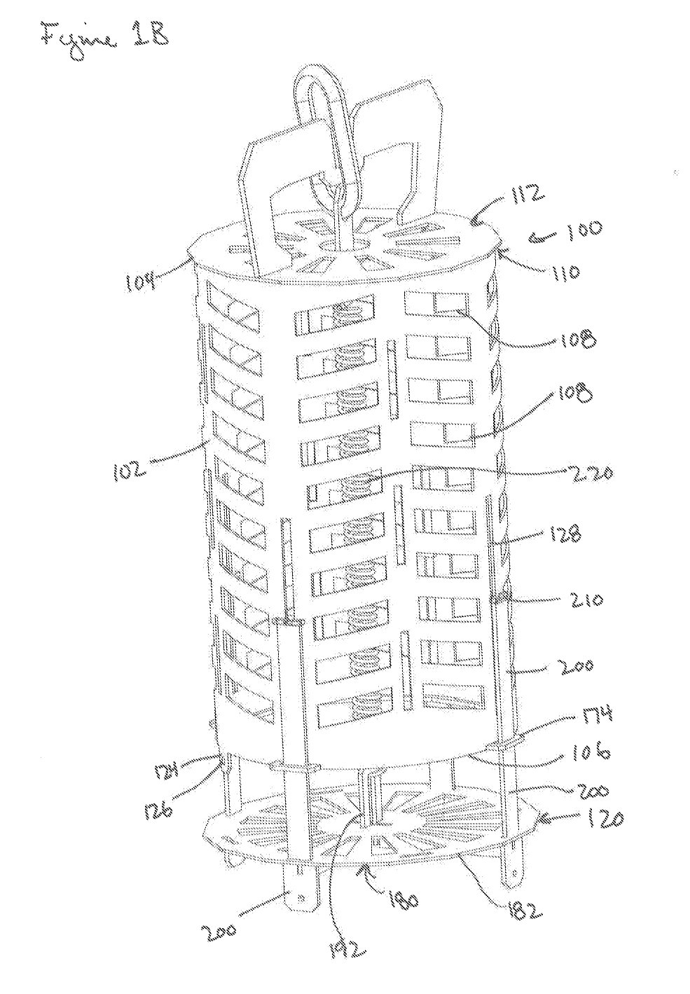

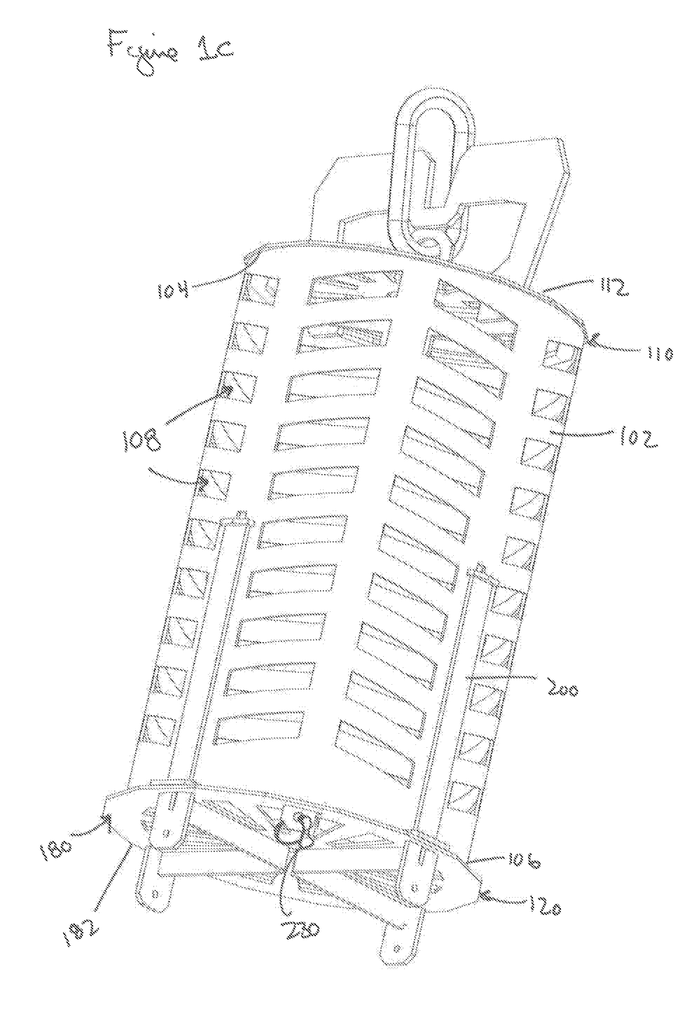

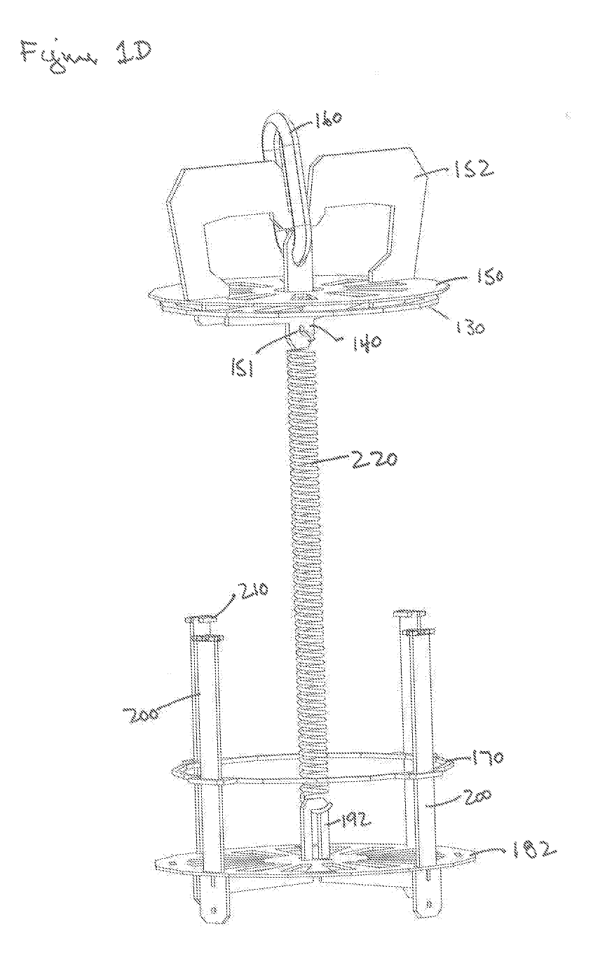

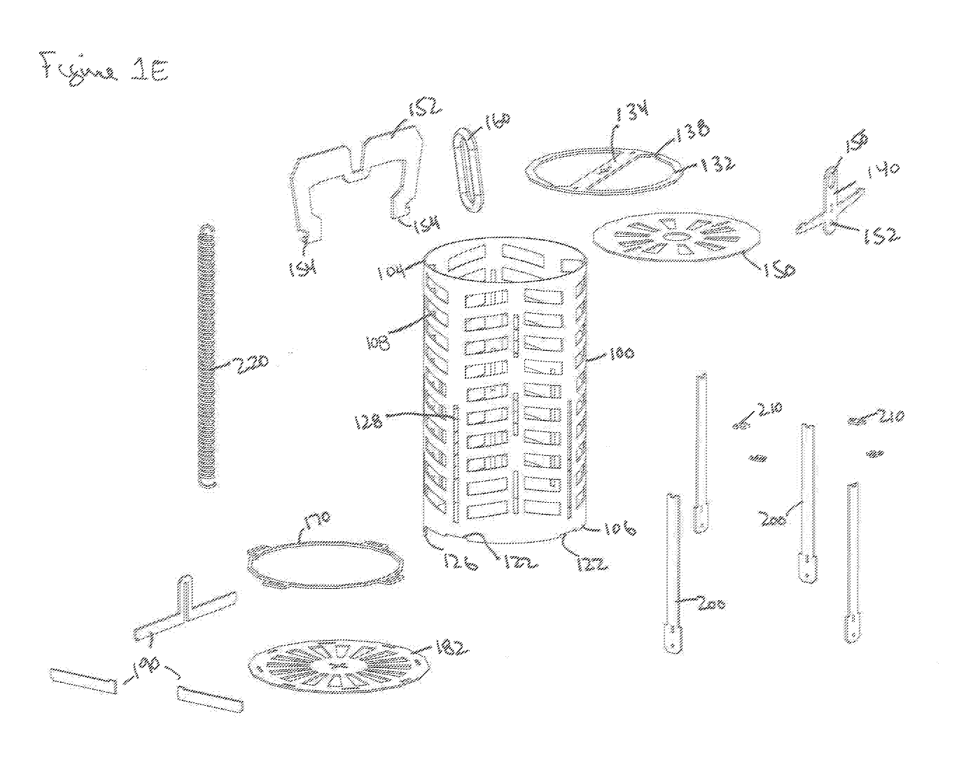

Referring now to FIGS. 1A through 1D, there is provided a hybrid chummer and chunker apparatus 100 in accordance with one or more embodiments of the present invention. The apparatus 100 is a controlled delivery container for the delivery of chum and chunks of bait or chum when submerged in the water. The apparatus 100 is geared towards use in sport, commercial, and recreational fishing and it provided as a unique delivery system unlike what is available in the prior art.

The apparatus 100 includes a cage 102 that has numerous or a plurality of openings 108 around the circumference of the cage 102 that are designed allow water in and out of the cage and allows bait or chum to exit the cage with submerged in water. In this fashion the hybrid apparatus can act as a chummer delivery system. The size, shape or disbursement of the openings 108 may be changed as desired and are not a focus of this particular invention. The openings 108 are also designed to allow water through the cage such that it can sink faster with less resistance in the water.

The apparatus 100 includes a top section 110 that is secured about the top end 104 of the cage. A top end cap 112 is also provided that is removably secured about the top section 110. When the top end cap 112 is removed the user has easy access to the inside of the cage to place bait, chum, or chunks. The apparatus 100 further includes a bottom end cap 120 that is moveably attached about the bottom end 106 of the cage 102. As explained in greater detail below, in one embodiment of the invention, when the apparatus 100 is submerged in water and the apparatus 100 is pulled upwardly, the bottom end cap 120 laterally moves away from the bottom end 106 of the cage 102 allowing for quick disbursement of the bait or chum inside the cage. In addition, the bottom end cap 120 can be secured to the bottom end of the cage 102 such that disbursement of the bait is done only through the chum openings 108 in the cage 102.

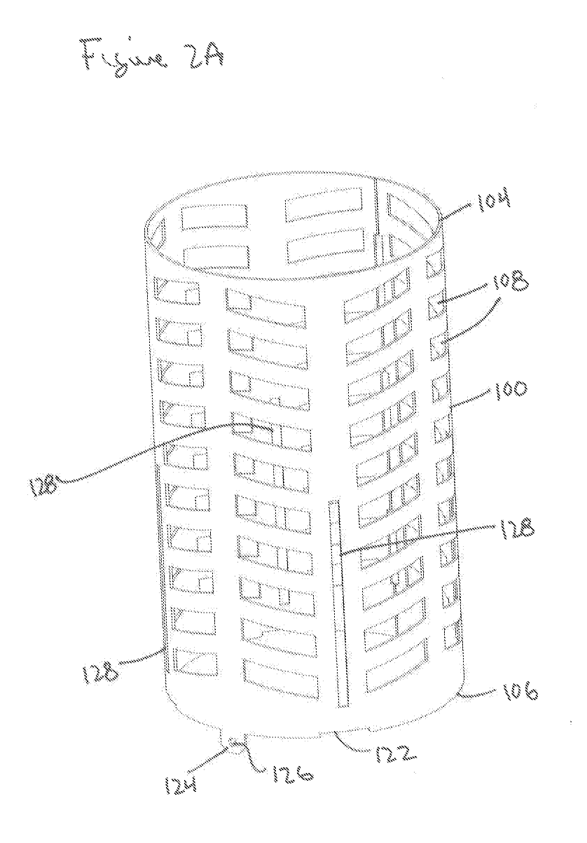

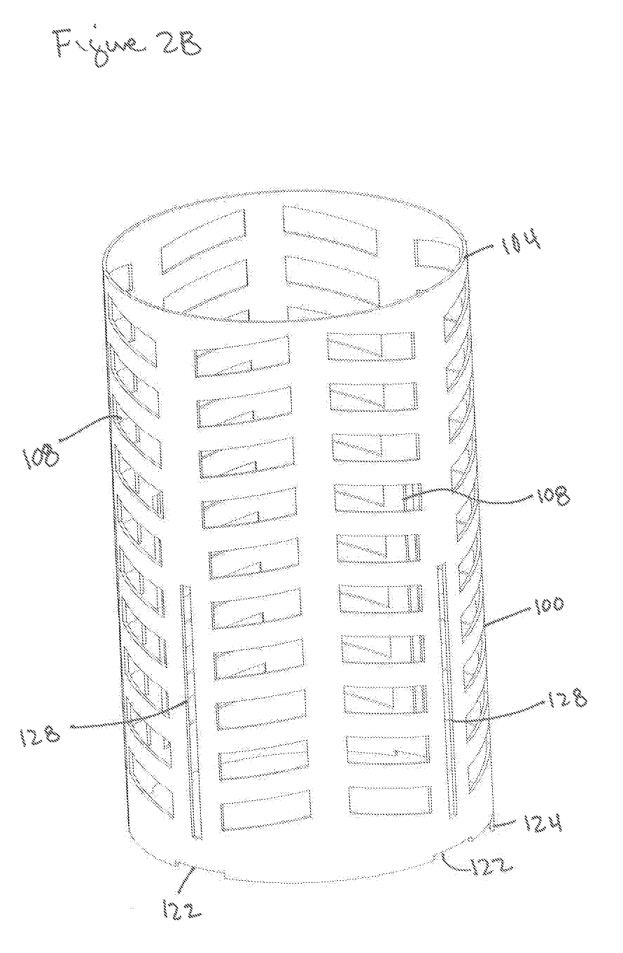

Referring also to FIGS. 2A and 2B, the cage 100 includes the top end 104 and bottom end 106 with a plurality of opening 108 surrounding the cage 100. The bottom end 106 includes a plurality of indented portions 122 and a tab 124 that extends below the bottom end 106. The tab 124 includes an aperture 126. In addition, the cage 100 includes vertical slots 128 positioned around the cage 104. As illustrated, the cage 100 in this single embodiment includes four vertical slots 128 and four indented portions 122 positioned equally around the cage.

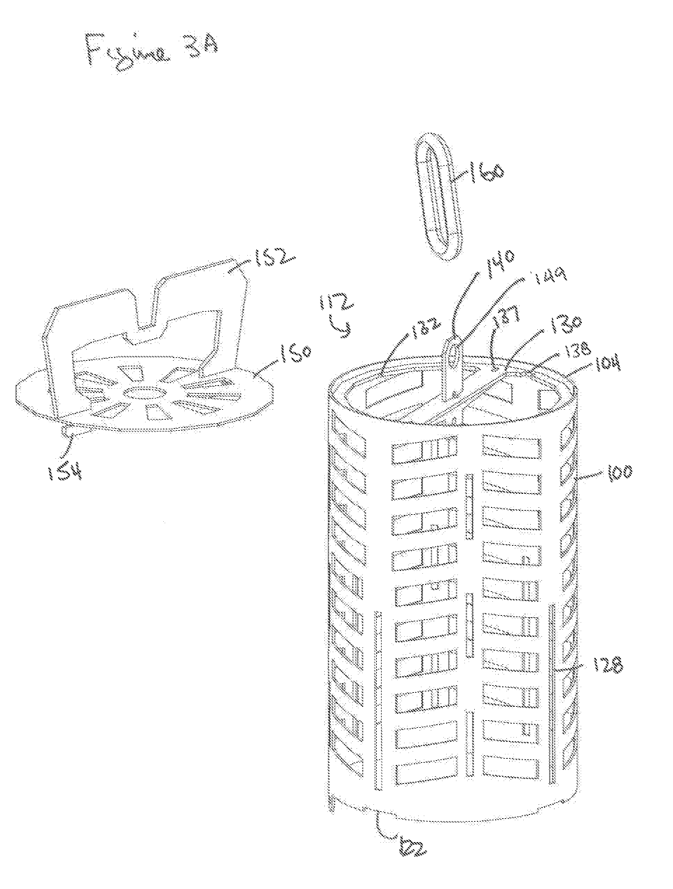

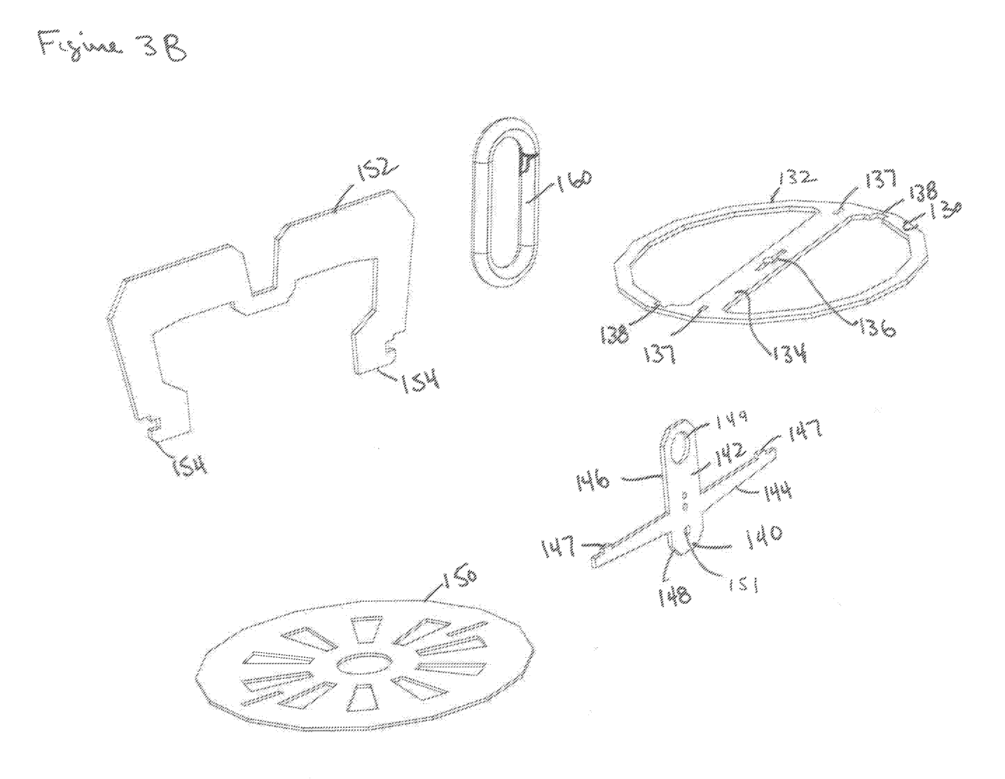

Referring now also to FIGS. 3A through 3C, there is illustrated the top section 110 that is removably secured to the top end of the cage 100. In one embodiment this is accomplished by having an upper structural ring 130 secured or mounted within the top end 104 of the cage 100. The upper structural ring 130 is an annual ring 132 that have a centered flange 134 expanding the diameter of the ring 130. The centered flange 134 includes a keyhole opening 136 about the middle of the centered flange 134 and a pair of opposing apertures 137 that are diametrically opposed on the centered flange 134 about the annual ring 132. In addition, the annual ring 132 includes a pair of opposed notches 138 positioned adjacent to the centered flange 134 and that face the interior of the annual ring 132. Mounted to the upper structural ring 130 is a top spring mount 140. The top spring mount 140 includes a vertical post 142 and a horizontal post 144 that extends outwardly from either side of the vertical post and for a position that allows the vertical post 142 to extend above and below the horizontal post 144, such that the two appear to intersect each other. A top portion 146 of the vertical post 142 above the horizontal post 144 is configured to extend through the keyhole opening 136, while a bottom portion 148 of the vertical post 142 below the horizontal post 144 will be positioned below the upper structural ring 130. In addition, on either side of the horizontal post 144 there are projection members 147 that fit into the opposing apertures 137 on the centered flange 134 of the upper structural ring 130. In addition, the vertical post 142 includes mounting openings 149 and 151 positioned on the top and bottom portions of the vertical post 142.

Continuing to refer to FIGS. 3A through 3C, the top section 110 further includes a lid 150 that is secured to a handle 152. The handle includes a pair of outwardly extending clips 154 that are positioned below the lid 150 and fit through the opposed notches 138 such that the clips 154 are capable of being positioned below the upper structural ring. The lid 150 is then rotated away from the opposed notches 138 such that the clips 154 engage upper structural ring and the lid is securely fashioned thereto. To remove the lid 150, the user can rotate the lid 150 until the clips 154 align with the opposed notches 138 and then lift the lid away from the cage. Once the lid 150 is secured to the cage 100, a clip 160 can be inserted or secured to the mounting opening 149 on the top portion of the vertical post 142.

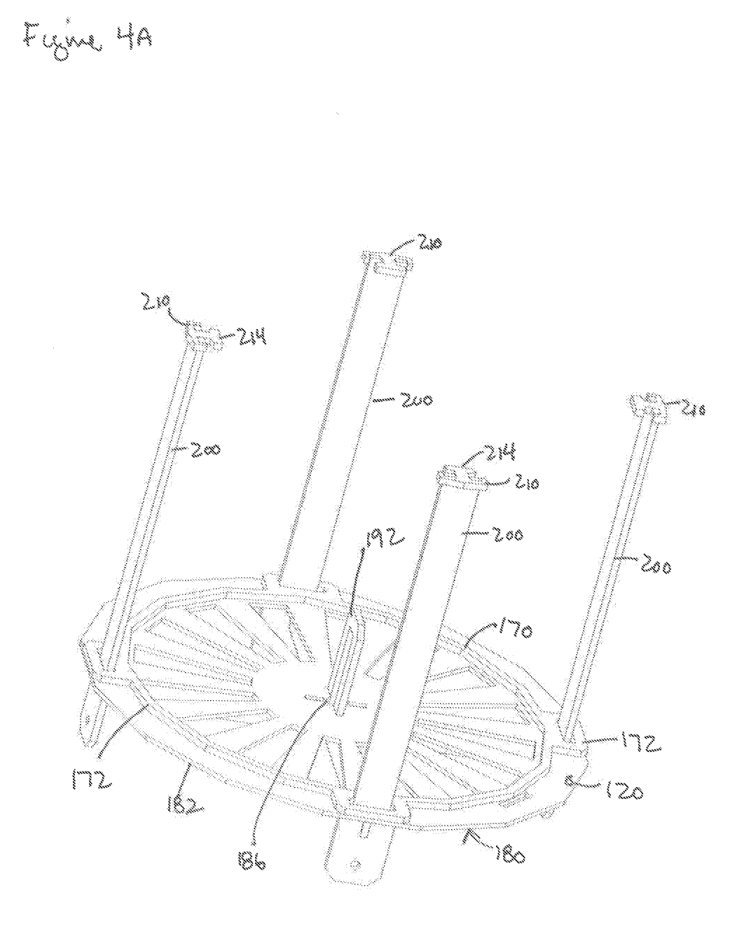

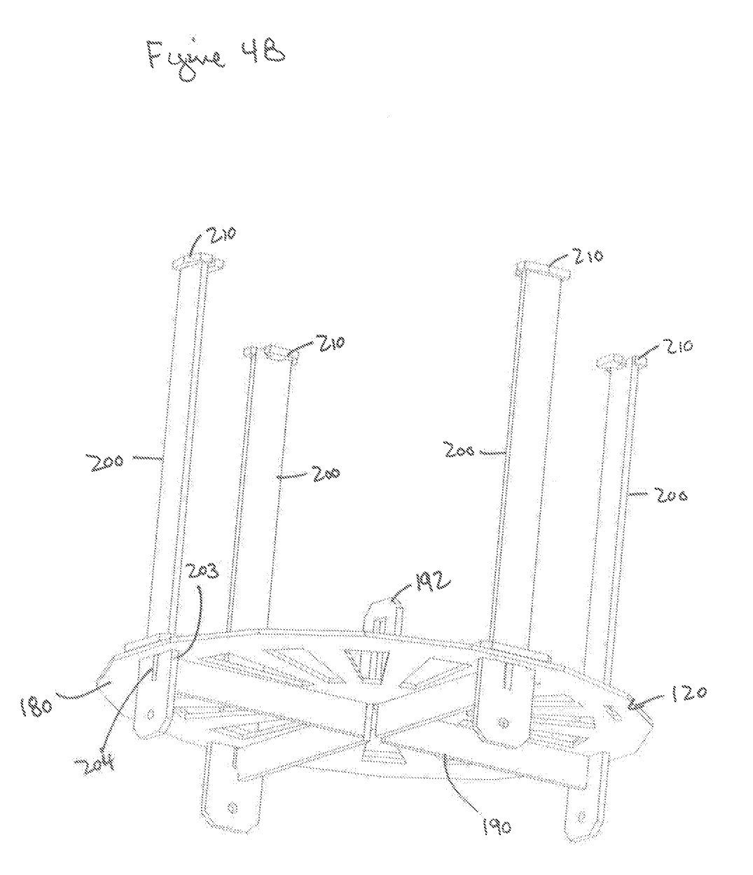

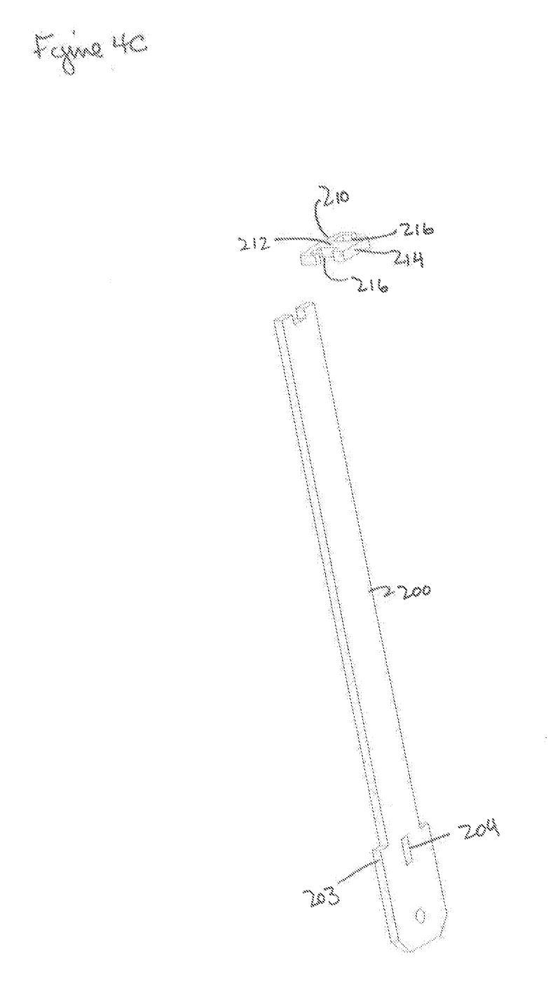

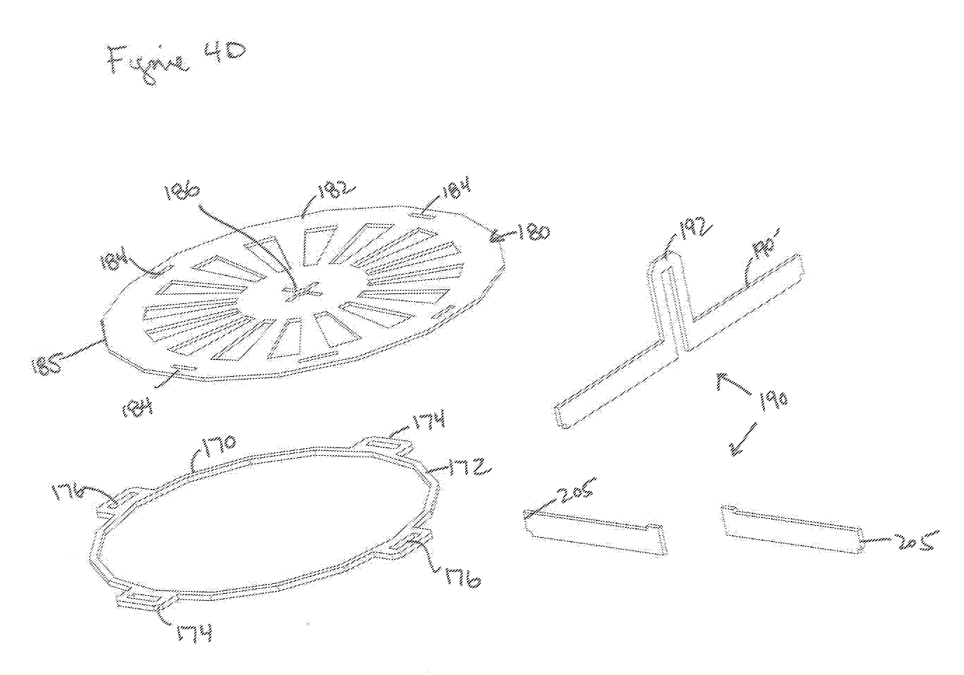

Referring now also to FIGS. 4A through 4D, there is further shown the bottom end cap 120 that is moveably attached about the bottom end 106 of the cage 102 (also shown in FIGS. 1A and 1B). The ability to move the bottom end cap 120 can be achieved by securing a lower structural ring 170 to the bottom end 106 of the cage 102 and having an tension base 180 movable in relation to the structural ring 170.

The structural ring 170 includes an annual ring 172 that would be attached or secured to the bottom end 106. The annual ring 172 also includes a plurality of bracket ends 174 projected outwardly from the annual ring 172 such that each of the bracket ends 174 has an opening 176 there through and configured at an exterior position to the cage 100. The tension base 180 includes a bottom plate 182, that includes a plurality of slots 184 about the peripheral edge 185 of the bottom plate 182 and that correspond to the openings 176 in the bracket ends 174. The bottom plate also includes a bottom key hole opening 186 about the center of the bottom plate. Braces 190 positioned below and against the bottom plate are provided and include an extension portion 192 on one of the braces 190′ that extends through the cross key hole opening 186.

In addition, a plurality of vertical arms 200 are positioned to extend separately through one of the slots 184 in the bottom plate 182 and the corresponding openings 176 in the bracket ends 174 on the annual ring 172. This permits the bottom end cap 120 to move vertically with the vertical arms 200 while staying aligned with the bottom of the cage 100. The lower portion 203 of the vertical arms 200 are also larger in width then the rest of the vertical arm 200 such that when inserted through the slots 184 in the bottom plate 182 movement stops at the lower portion 203. The vertical arms 200 further include a channel or notch 204 to receive an end 205 of one of the brackets 190 keeping the braces 190 in position. Each vertical arm 200 further includes an upper cap 210 that is secured to a top portion 202 of the vertical arms 200. Each upper cap 210 includes a finger 212 projecting towards the center of the cage 100 with a flared end 214 and grooved notches 216 along the finger leading to the flared end 214. When positioned, the flared end 214 rests inside the cage 100 with the grooved notches 216 positioning the finger 212 through the slot 128 along the cage 100. The upper cap 210 serves as stops at a top position on the slot 128 and bottom position on the slot 128 preventing the vertical arms 200 and thus the bottom end cap 120 from separating away from the bottom of the cage 100.

When assembled, the plurality of indented portions 122 along the bottom end 106 of the cage 100 fit above the bracket ends 174 on the annual ring 172 allowing the bottom of the cage 100 to sit against the bottom plate 182 when in a rest position.

Continuing to refer to the figures and to FIG. 1B, a tension spring 220 is further provided with one end connected to the opening 151 positioned on the bottom portion of the vertical post 142 and the other end connected to the extension portion 192 on the brace 190′ that extends through the cross key hole opening 186. As such the bottom end cap 120 is secured to the cage 100 by the tension spring 220. When submerged in water, the user can simply tug on the cage (through a line or rope attached to the top of the cage) and the force of the water acting on the bottom end cap 120 when separate and move the bottom end cap 120 away from the bottom of the cage 100. When the movement stops, the tension spring 220 will bring the bottom end cap 120 back against the bottom of the cage 100.

In addition, as noted above the bottom of the cage 100 includes the tab 124 and aperture 126. When in the rest position (FIG. 1C), the tab 124 extends through one of the slots 184 along the bottom plate 182. As such, the user may insert a lock or pin or other type of member 230 through the aperture 126 on the tab 124 and thus lock the tension base 180 to the bottom of the cage and thus prevent the tension base 180 from separating during movement in the water. Thus may be done when the user want to simply chum the water slowly over time.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

We claim:

1. A hybrid chummer and chunker apparatus comprising:
a cage that has a plurality of openings around the circumference of the cage that are designed to allow water in and out of the cage and allow chum or bait contained within the cage to exit the cage when submerged in water;
a top section secured about a top end of the cage, the top section is removably secured about the top section to allow the placement of chum or bait;
a bottom end cap that is positioned about a bottom end of the cage, the bottom end cap is further configured to move away from the bottom end of the cage in one instance to release chunks of chum or bait; and
a tension spring secured between the top section and the bottom end cap, the tension spring configured to permit the bottom end cap to move away from the bottom end of the cage when submerged in water and when the apparatus is pulled through the water with a force that exceeds a force exerted by the tension spring.

2. The apparatus of claim 1, wherein the bottom end of the cage includes a tab with an aperture, the tab is configured to extend through a slot defined on the bottom end cap and wherein the apparatus further includes a locking device configured to fit through the aperture of the tab when the tab extends through the slot such that the bottom end cap of the cage is locked against the bottom end of the cage preventing movement of the bottom end cap when submerged in water and thereby converting the apparatus into a chummer apparatus.

3. The apparatus of claim 1, wherein the cage includes a plurality of openings surrounding the cage, a plurality of indented portions about the bottom end of the cage and at least one vertical slot positioned about the cage.

4. The apparatus of claim 1, wherein the top section is removably secured to the top end of the cage.

5. The apparatus of claim 4, wherein the top section includes:
an upper structural ring secured within the top end of the cage, the upper structural ring has an annual ring with a centered flange expanding the diameter of the annual ring, the centered flange includes a keyhole opening about a middle area of the centered flange, and the annual ring further includes a pair of opposed notches positioned adjacent to the centered flange and that face the interior of the annual ring;
a top spring mount having a vertical post and a horizontal post that extends outwardly from either side of the vertical post and for a distance that allows the vertical post to extend above and below the horizontal post, the vertical post has a top portion above the horizontal post that is configured to extend through the keyhole opening, the vertical post further has a bottom portion below the horizontal post positioned below the upper structural ring, the bottom portion further includes an opening to receive an upper portion of the tension spring; and
a lid having a handle extending therefrom, the handle includes a pair of outwardly extending clips positioned below the lid and which fit through the opposed notches defined on the upper structural ring such that the clips are configured to position below the upper structural ring,
wherein when the lid is rotated away from the opposed notches such that the clips engage the upper structural ring, the lid is securely fashioned thereto and when the lid is rotated such that the clips align with the opposed notches, the lid is removable from the cage.

6. The apparatus of claim 5, wherein the horizontal post further includes projection members on either side thereof and the projection member fit into opposing apertures defined on the centered flange of the upper structural ring.

7. The apparatus of claim 5, further comprising a clip attached to a mounting opening on the top portion of the vertical post that extends through the keyhole opening.

8. The apparatus of claim 1, wherein the bottom end cap includes:
a lower structural ring secured to the bottom end of the cage; and
a tension base movable in relation to the structural ring.

9. The apparatus of claim 1, wherein the bottom end cap includes:
a lower annual ring attached to the bottom end of the cage, the lower annual ring includes a plurality of bracket ends projected outwardly from the annual ring, each bracket end has an opening there through and is configured at a position exterior to the cage; and
a tension base movable in relation to the lower structural ring, and wherein the tension base includes:
a bottom plate having a plurality of slots about a peripheral edge defined along the bottom plate and the plurality of slots correspond to the openings in the bracket ends, the bottom plate also includes a bottom key hole opening about a center area of the bottom plate,
a plurality of braces are positioned below and against the bottom plate, and one of the braces includes an portion extending through the cross key hole opening, the portion extending through the cross key hole opening includes an aperture for receiving a lower end of the tension spring; and
a plurality of vertical arms, each vertical arm being separately positioned to extend through one of the slots in the bottom plate and the corresponding opening in the bracket end on the lower annual ring, each vertical arm has a lower portion with a width that is larger than an upper portion such that when the vertical arm is inserted through the slot movement stops at the lower portion, each vertical arm includes an upper cap that is secured to a top portion of the vertical arms, the upper cap having a flared end resting inside the cage along the slot defined on the cage, such that the vertical arms can slide along the slots on the cage,
thus allowing the tension base to move away from the bottom end of the cage when a force is exerted against the tension base that is greater than the tension spring and the tension base has a tendency to return to rest against the bottom end of the cage when forces exerted by the tension spring exceeds any forces against the tension base.

10. The apparatus of claim 9, wherein each vertical arm includes a notch to receive an end of one of the brackets, such that the braces are maintained in position against the bottom plate.

11. The apparatus of claim 10, wherein the bottom end of the cage includes indented portions that rest over the bracket ends on the annual ring, permitting the bottom of the cage to sit against the bottom plate when in a rest position.

12. A hybrid chummer and chunker apparatus comprising:
a cage that has a plurality of openings around the circumference of the cage that are designed to allow water in and out of the cage and allow chum or bait contained within the cage to exit the cage when submerged in water;
a top section secured about a top end of the cage, the top section is removably secured about the top section to allow the placement of chum or bait;
a bottom end cap that is positioned about a bottom end of the cage, the bottom end cap is further configured to move away from the bottom end of the cage in one instance to release chunks of chum or bait that are larger than the chum or bait released through the plurality of openings around the cage;
a tension spring secured between the top section and the bottom end cap, the tension spring configured to permit the bottom end cap to move away from the bottom end of the cage when submerged in water and when the apparatus is pulled through the water with a force that causes an exerted force on the bottom end cap that exceeds a force exerted by the tension spring and the tension spring being further configured to return to rest causing the bottom end of the case to shut against the bottom end of the cage when forces exerted by the tension spring exceeds the forces against the bottom end cap.
wherein the bottom end of the cage includes a tab with an aperture, the tab is configured to extend through a slot defined on the bottom end cap and wherein the apparatus further includes a locking device configured to fit through the aperture of the tab when the tab extends through the slot such that the bottom end cap of the cage is locked against the bottom end of the cage preventing movement of the bottom end cap when submerged in water.

13. The apparatus of claim 12, wherein the top section is removably secured to the top end of the cage and the top section is defined by having:
an upper structural ring secured within the top end of the cage, the upper structural ring has an annual ring with a centered flange expanding the diameter of the annual ring, the centered flange includes a keyhole opening about a middle area of the centered flange, and the annual ring further includes a pair of opposed notches positioned adjacent to the centered flange and that face the interior of the annual ring;
a top spring mount having a vertical post and a horizontal post that extends outwardly from either side of the vertical post and for a distance that allows the vertical post to extend above and below the horizontal post, the vertical post has a top portion above the horizontal post that is configured to extend through the keyhole opening, the vertical post further has a bottom portion below the horizontal post positioned below the upper structural ring, the bottom portion further includes an opening to receive an upper portion of the tension spring; and
a lid having a handle extending therefrom, the handle includes a pair of outwardly extending clips positioned below the lid and which fit through the opposed notches defined on the upper structural ring such that the clips are configured to position below the upper structural ring,
wherein when the lid is rotated away from the opposed notches such that the clips engage the upper structural ring, the lid is securely fashioned thereto and when the lid is rotated such that the clips align with the opposed notches, the lid is removable from the cage.

14. The apparatus of claim 13, wherein the horizontal post further includes projection members on either side thereof and the projection member fit into opposing apertures defined on the centered flange of the upper structural ring.

15. The apparatus of claim 13, wherein the bottom end cap includes:
a lower annual ring attached to the bottom end of the cage, the lower annual ring includes a plurality of bracket ends projected outwardly from the annual ring, each bracket end has an opening there through and is configured at a position exterior to the cage; and
a tension base movable in relation to the lower structural ring, and wherein the tension base includes:
a bottom plate having a plurality of slots about a peripheral edge defined along the bottom plate and the plurality of slots correspond to the openings in the bracket ends, the bottom plate also includes a bottom key hole opening about a center area of the bottom plate,
a plurality of braces are positioned below and against the bottom plate, and one of the braces includes an portion extending through the cross key hole opening, the portion extending through the cross key hole opening includes an aperture for receiving a lower end of the tension spring; and
a plurality of vertical arms, each vertical arm being separately positioned to extend through one of the slots in the bottom plate and the corresponding opening in the bracket end on the lower annual ring, each vertical arm has a lower portion with a width that is larger than an upper portion such that when the vertical arm is inserted through the slot movement stops at the lower portion, each vertical arm includes an upper cap that is secured to a top portion of the vertical arms, the upper cap having a flared end resting inside the cage along a slot defined on the cage, such that the vertical arms can slide along the slots on the cage,
thus allowing the tension base to move away from the bottom end of the cage when a force is exerted against the tension base that is greater than the tension spring and the tension base has a tendency to return to rest against the bottom end of the cage when forces exerted by the tension spring exceeds any forces against the tension base.

16. The apparatus of claim 15, wherein the bottom end of the cage includes indented portions that rest over the bracket ends on the annual ring, permitting the bottom of the cage to sit against the bottom plate when in a rest position.

17. A hybrid apparatus convertible between a chummer apparatus and a chunker apparatus, the hybrid apparatus comprising:
a cage having a plurality of openings configured to allow water in and out of the cage when submerged in water and further configured to allow chum or bait contained within the cage to exit there through;
a top section secured about a top end of the cage, the top section is removably secured about the top section to allow placement of chum or bait into the cage;
a bottom end cap that is positioned about a bottom end of the cage; and
a tension spring secured to the top section and secured to the bottom end cap, the tension spring configured to permit movement of the bottom end cap away from the bottom end of the cage when a force exerted on the bottom end cap exceeds a force exerted by the tension spring and further configured to return or maintain the bottom end cap against the bottom end of the cage when the force exerted by tension spring is greater than the force exerted on the bottom end cap, and wherein
the hybrid apparatus is configured as a chummer apparatus when submerged in water and the chum or bait contained within the cage disperses through one or more of the plurality of openings around the circumference of the cage, and
the hybrid apparatus is configured as a chunker apparatus when submerged in water and the bottom end cap is moved away from the bottom end of the cage to permit chunks of the chum and bait, and portions of the chum and bait contained within the cage to disperse through the bottom of the cage.

18. The hybrid apparatus of claim 17 further comprising a locking device to secure the bottom end cap to the bottom end of the cage such that the hybrid apparatus is configured only as the chummer apparatus until the locking device is removed.
